(19) United States
(12) Patent Application Publication
(10) Pub. No.: US 2026/0197258 A1
(43) Pub. Date: Jul. 9, 2026

(54) CLOUD RESIDUAL RISK ASSESSMENT TOOL

(71) Applicant: Wells Fargo Bank, N.A., San Francisco, CA (US)

(72) Inventor: Tanweer Surve, Coppell, TX (US)

(21) Appl. No.: 19/555,613

(22) Filed: Mar. 3, 2026

Related U.S. Application Data
(63) Continuation of application No. 18/187,461, filed on Mar. 21, 2023, now Pat. No. 12,592,869.

(51) Int. Cl. H04L 41/5009; H04L 41/0897

(52) U.S. Cl. CPC H04L 41/5009; H04L 41/0897

(57) ABSTRACT

Certain aspects of the disclosure pertain to a cloud residual risk assessment tool. A system can obtain current risk data representing a current operational state of an application on a current host, and target state configuration data defining a proposed computing environment on a future host, wherein the configuration data comprises a control mapping defining security or compliance objectives. The system can determine a second aggregate residual risk score for the future host by analyzing the control mapping to determine if the proposed environment satisfies the objectives, without executing the application. A first aggregate residual risk score can be determined for the current host based on the current risk data. Further, the system can automatically authorize migration of the application to the future host when the second aggregate residual risk score indicates a lower risk level than the first aggregate residual risk score.

### CROSS REFERENCE TO RELATED APPLICATIONS

This application is a continuation of U.S. Patent Application Number 18/187,461, filed March 21, 2023, and entitled “Cloud Residual Risk Assessment Tool,” the entirety of which is incorporated herein by reference.

### TECHNICAL FIELD

This disclosure relates to computer software applications and systems, in particular, computer systems that support migrating assets to a new hosting environment based on residual risk scores calculated based on quantitative and qualitative risk factors.

### BACKGROUND

With the development of host environment technology, such as cloud hosting environments, corporations may consider migrating sensitive assets to a more advanced hosting environment. Corporations may define objectives and requirements of hosting environments and analyze whether a given hosting environment satisfies the objective and requirements. This is a complex process that is done manually through the collaboration of many different personnel across different lines of businesses.

### SUMMARY

In general, this disclosure describes a computer system configured to analyze residual risks of hosting environments while migrating software-based assets from one host environment to another host environment. Host environments may include hardware, software, management environment, and other computing resources including internal corporate computing systems, third-party cloud services, or other computing systems. Host environments may be used to provide a reliable infrastructure to execute software applications or maintain other software-based assets, such as confidential information stored on one or more computing systems. With the advancement of host environment technology, such as contemporary cloud services, corporations may decide to migrate assets from an internal host environment to a third-party host environment. However, corporations have a need for determining risks of the third-party host environment to guarantee that risks that may be harmful to assets of the current hosting environment are mitigated. The techniques described in this disclosure include an automated way of determining whether a future hosting environment minimizes potential risks to support the migration of assets from the current host to the future host.

In one example, this disclosure is directed to a method, the method comprising obtaining, by one or more processors, current risk data representing a current operational state of an application on a current host, obtaining, by the one or more processors, target state configuration data defining a proposed computing environment on a future host, wherein the target state configuration data comprises a control mapping that defines control objectives comprising security or compliance requirements for the future host, determining, by the one or more processors, a second aggregate residual risk score for the future host by analyzing the control mapping associated with the future host to determine whether the proposed computing environment satisfies the control objectives, without executing the application on the future host, determining, by the one or more processors, a first aggregate residual risk score for the current host based on the current risk data, and automatically authorizing, by the one or more processors, a migration of the application to the future host when the second aggregate residual risk score indicates a lower risk level than the first aggregate residual risk score.

In another example, this disclosure is directed to a device comprising at least one processor, and at least one memory storing computer-executable instructions that, when executed by the at least one processor, cause the device to obtain current risk data representing a current operational state of an application on a current host, obtain target state configuration data defining a proposed computing environment on a future host, wherein the target state configuration data comprises a control mapping that defines control objectives comprising security or compliance requirements for the future host, determine a second aggregate residual risk score for the future host by analyzing the control mapping associated with the future host to determine whether the proposed computing environment satisfies the control objectives, without executing the application on the future host, determine a first aggregate residual risk score for the current host based on the current risk data, and automatically authorize a migration of the application to the future host when the second aggregate residual risk score indicates a lower risk level than the first aggregate residual risk score.

In another example, this disclosure describes a non-transitory computer readable storage medium storing instructions that, when executed, cause one or more processors of a server device to obtain current risk data representing a current operational state of an application on a current host, obtain target state configuration data defining a proposed computing environment on a future host, wherein the target state configuration data comprises a control mapping that defines control objectives comprising security or compliance requirements for the future host, determine a second aggregate residual risk score for the future host by analyzing the control mapping associated with the future host to determine whether the proposed computing environment satisfies the control objectives, without executing the application on the future host, determine a first aggregate residual risk score for the current host based on the current risk data, and automatically authorize a migration of the application to the future host when the second aggregate residual risk score indicates a lower risk level than the first aggregate residual risk score.

### BRIEF DESCRIPTION OF DRAWINGS

FIG. 1 is a block diagram of an example system illustrating techniques described herein.

FIG. 2 is an example computing system 200 used to assess and compare residual risks of one or more hosting environments.

FIG. 3 is a flowchart illustrating an example operation 300 in accordance with techniques described herein.

FIG. 4 is an example operation 400 in accordance with the techniques described in this disclosure.

FIG. 5 is a block diagram illustrating an example operation of aggregating risk scores of a current host and a future host.

### DETAILED DESCRIPTION

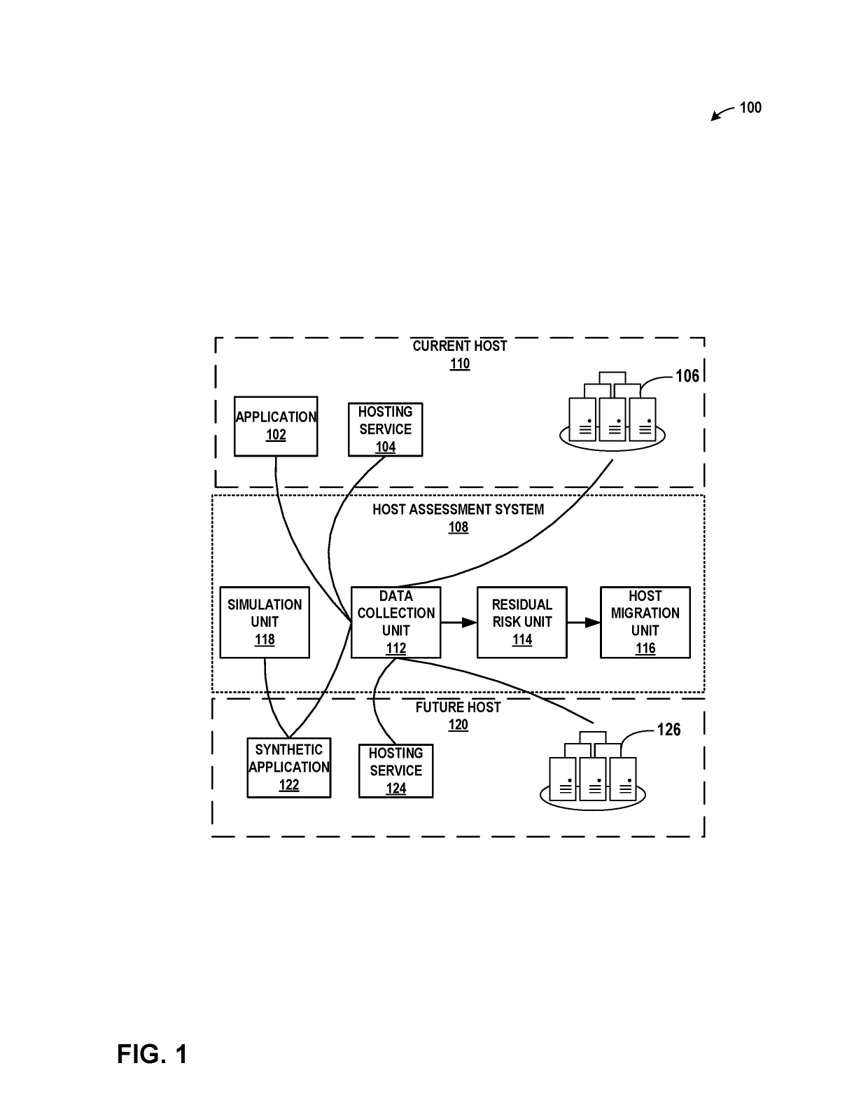

FIG. 1 is a block diagram of an example system illustrating techniques described herein. Example system 100 includes current host 110, host assessment system 108, and future host 120. Host assessment system 108 may include data collection unit 112. Data collection unit 112 may collect risk factors from an application domain, hosting service domain, and data center domain of current host 110 and future host 120. Host assessment system 108 may also include simulation unit 118. Simulation unit 118 may send synthetic data to future host 120 to generate synthetic application 122 for data collection unit 112 to obtain risk factors associated with the application domain of future host 120. Host assessment system 108 may also include residual risk unit 114 to calculate aggregated residual risk scores of current host 110 and future host 120. Residual risk is the exposure that remains after risk management or control activities are accounted for. Host assessment system 108 may also include host migration unit 116. Host migration unit 116 may analyze the aggregated residual risk scores of current host 110 and future host 120 to determine whether host migration unit 116 should migrate assets from current host 110 to future host 120.

In accordance with techniques of this disclosure, host assessment system 108 may determine aggregated residual risk scores for each of current host 110 and future host 120 and decide whether future host 120 presents less residual risk than current host 110 to support a migration to future host 120. Host assessment system 108 may contain data collection unit 112, residual risk unit 114, host migration unit 116, and simulation unit 118.

Host assessment system 108 may assess a host (e.g., current host 110 or future host 120) to measure residual risks of the host based on one or more quantitative and qualitative risk factors. Data collection unit 112 of host assessment system 108 may obtain a plurality of records (e.g., system of records) containing data indicating risks associated with one or more risk factors of a particular domain. Data collection unit 112 may obtain the records by initiating one or more software tools (e.g., Remedy, ServiceNow, RSA Archer, Technology & Cybersecurity Policy Exception tool, JIRA, Confluence, Metrics for Data Repositories, Cloud Control Framework, Cloud Security Alliance (CSA) Framework, COBIT Framework, NIST/FedRAMP, Cybersecurity Tools, etc.) that gather data identifying risks associated with one or more quantitative and qualitative risk factors. Data collection unit 112 may obtain the records from a plurality of domains, such as application 102 executing in current host 110, hosting service 104 executing in current host 110, data center 106 executing in current host 110, synthetic application 122 generated by simulation unit 118 and deployed in future host 120, hosting service 124 executing in future host 120, and data center 126 executing in future host 120. In some implementations, data collection unit 112 may obtain risk data from future host 120 with synthetic data simulation unit 118 generates and sends to future host 120 (e.g., simulation unit 118 generating synthetic application which is then probed by data collection unit 112 to collect records containing risks associated with synthetic application 122 executing in future host 120). Data collection unit 112 may organize the records in a map or table that correlates the domain of a particular host with the risks obtained from data collection unit 112. The structure of the data indicating a risk obtained by data collection unit 112 depends on the risk factor associated with the risk.

Quantitative and qualitative risk factors may be applied across one or more domains of a hosting environment based on a hosting strategy a corporation implements. The application domain may include risk factors that assess risks associated with migrating one or more applications or software programs. The hosting service domain may include risk factors that assess risks associated with the capability, security, etc. of services implemented to host the corporation’s applications and assets. The data center domain may include risk factors that assess risks associated with the resiliency, capability, security, etc. of servers used to host a corporation’s applications and assets.

In some examples, quantitative risk factors of an application domain (e.g., application 102 or synthetic application 122) may include the hosting environment (e.g., the physical and virtual environments encompassing the software, applications, and systems as a whole), open issues or corrective actions for an application, data sensitivity levels & ratings, policy exceptions (e.g., pre-approved suspension of one or more policy requirements), Technology & Security control applicability (e.g., Cloud Control Framework), application health score, application dependencies risk, migration strategy (e.g., evaluating assets to determine the best way to migrate or modernize each asset), and an organization (e.g., measuring effectiveness of an organization’s personnel and infrastructure). Quantitative risk factors of a hosting service domain (e.g., hosting service 104 or hosting service 124) may include open issues or corrective actions of the hosting service, policy exceptions, Technology & Security control applicability, enterprise data center services (e.g., metrics of a data center service’s availability, space, or power), supplier or vendor management, control design, information security risk assessment (e.g., risks to operations and asset from potential unauthorized access, use, disclosure, disruption, modification of information and/or information systems), continuous monitoring metrics, and an organization. Quantitative risk factors of a data center domain (e.g., data center 106 or data center 126) may include the hosting environment, open issues or corrective actions, policy exceptions, Technology & Security control applicability, enterprise data center services, supplier or vendor management, and organization.

In some examples, qualitative risk factors may be applied across the application domain, the hosting service domain, or the data center domain and may include risk factors that assess an asset migration strategy implemented by an information technology (IT) specialist or the organization and people within the organization holding the assets. Specific qualitative risk factors for assessing the asset migration strategy may include how the domain under analysis manages assets or the domain’s qualitative compliance with legal and industry standards (e.g., SOC2). Specific qualitative risk factors for assessing an organization and people associated with the domain under analysis may include the maturity of the organization, the culture or vision of the corporation, the skills or talent of the organization’s personnel, the organization’s accountability, training or upskilling undertaken by the organization, the organization’s communication of strategy, or other performance measurements of the quality of a hosting environment provided by the organization. Data collection unit 112 may obtain data defining qualitative risks factors based on one or more scores based on metrics established by an IT specialist or other corporate managers.

Residual risk unit 114 may also aggregate all the residual risk scores assigned to each risk obtained from a particular host (e.g., current host 110 or future host 120). In some implementations, residual risk unit 114 may aggregate the residual risk scores by taking the average of risk scores assigned to each risk. In other implementations, residual risk unit 114 may aggregate the residual risk scores by taking the sum of risk scores assigned to each risk. Residual risk unit 114 may aggregate both the set of residual risk scores assigned to each risk obtained from current host 110 and the set of residual risk scores assigned to each risk obtained from future host 120. Residual risk unit 114 may then send the aggregated residual risk score of current host 110 and future host 120 to host migration unit 116. Host migration unit 116 may compare the aggregated residual risk scores of current host 110 and future host 120 to determine whether the aggregated residual risk score of future host 120 is less than the aggregated residual risk score of current host 110. In response to host migration unit 116 determining that the aggregated residual risk score of future host 120 is greater than the aggregated residual risk score of current host 110, host migration unit 116 may issue an alert to an administrator that future host 120 poses more risk than current host 110 and recommend that future host 120 not be used. In response to host migration unit 116 determining that the aggregated residual risk score of future host 120 is less than the aggregated residual risk score of current host 110, host migration unit may migrate assets from current host 110 to future host 120.

The techniques described herein provide an automated way to determine whether to migrate assets from a current host to a future host. Typically, comparing residual risks of hosts is done manually and becomes unwieldy for personnel of a corporation to handle. By automatically comparing residual risk scores of a current host and future host to support a migration of assets from the current host to the future host, corporations may be confident in the determination that the future host poses less risk than the current host. The techniques described herein are a scalable solution that allows personnel of the corporation to easily determine whether a future host reduces risk of hosting valuable assets after all the controls of the hosting environment are considered and addressed.

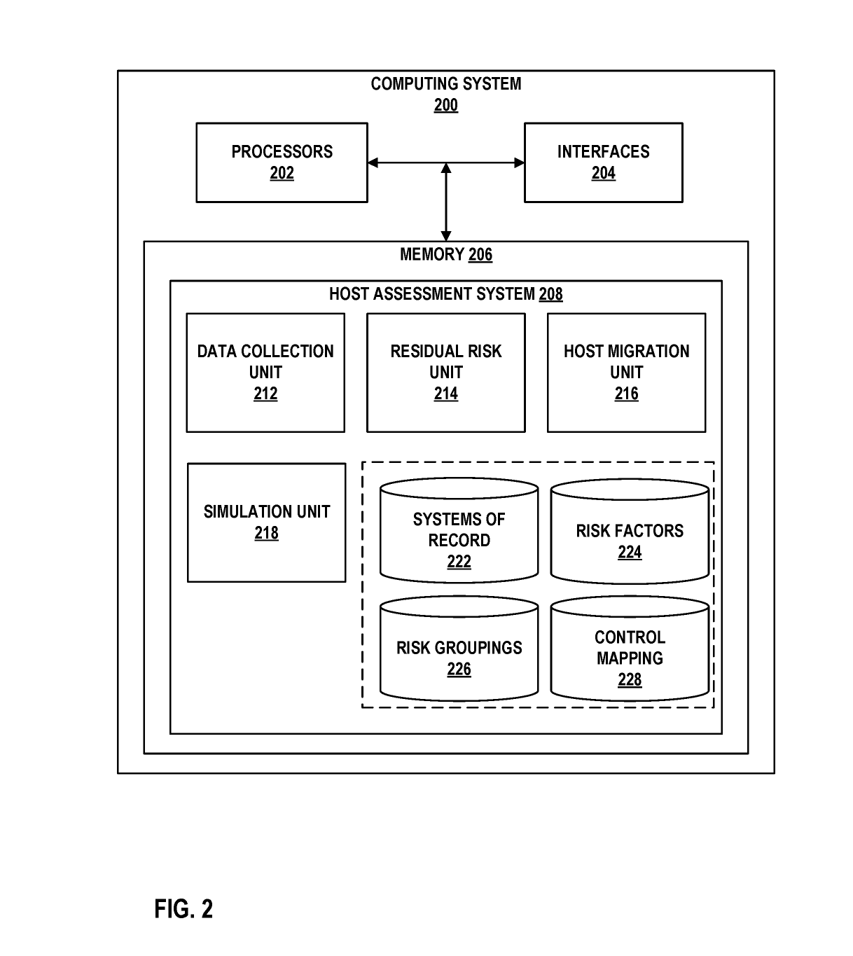

FIG. 2 is an example computing system 200 used to assess and compare residual risks of one or more hosting environments. Computing system 200 may include processors 202, interfaces 204, and memory 206 all coupled together. Memory 206 may include host assessment system 208. Host assessment system 208 may include data collection unit 212, residual risk unit 214, host migration unit 216, and simulation unit 218. Host assessment system 208 may also store data in systems of record 222, risk factors 224, risk groupings 226, and control mapping 228.

Data collection unit 212 of host assessment system 208 may use one or more software tools to obtain data representing risks from each domain of a current host or future host and store the data in systems of record 222. In some instances, when host assessment system 208 is analyzing the application domain of a future host, there is no application or software executing on the future host to analyze. Host assessment system 208 may use simulation unit 218 to generate a synthetic application (e.g., synthetic application 122 of FIG. 1) to send to the future host and monitor how the future host processes the synthetic application. The synthetic application may embody characteristics of applications executing on the current host. Data collection unit 212 may simulate disaster recovery (DR) scenarios, conduct penetration tests, etc. to monitor the future host’s ability to securely store and manage the synthetic application. In response to data collection unit 212 monitoring the future host processing the synthetic application, data collection unit 212 may use one or more software tools discussed above to obtain data representing risks in the application domain of the future host based on the monitoring.

In some implementations, residual risk unit 214 of host assessment system 208 may calculate residual risk of a current host (e.g., current host 110 of FIG. 1) and a future host (e.g., future host 120) to determine whether host migration unit 216 should migrate assets from the current host to the future host. Residual risk unit 214 may assign a residual risk score to the risks obtained by data collection unit 212 and stored in systems of record 222. Residual risk unit 214 may assign each risk a residual risk score based on risk groupings of the quantitative and qualitative risk factors described above. Host assessment system 208 may establish and store the quantitative and qualitative risks in risk factors 224. Risk groupings 226 may store the mapping of a plurality of groups to a particular risk factor, where each group includes a residual risk score associated with a range of potential values of risks associated with a particular risk factor. Residual risk unit 214 or a corporation’s IT specialist (via interfaces 204) may establish groups with a numerical residual risk score value based on potential values of risks associated with a particular risk factor. For example, when host assessment system 208 is determining the residual risk score of the application domain, residual risk unit 214 may group risks associated with the risk factor of Application Health Score based on the four potential values of a risk associated with Application Health Score (low, medium, high, or critical). Residual risk unit 214 may establish groups for each of these potential values that includes a residual risk score associated with the level of risk presented by each potential value (e.g., low = 1, medium = 2, high = 3, critical = 4). In another example, residual risk unit 214 establishes groups with a corresponding residual risk score for risks associated with the risk factor of Application Dependency Risk based on the number of parent/child relationships and assign each group (e.g., 0 parent/child = 0, 1 parent/child = 1, >1 and ≤5 parent/child = 2, and >5 parent/child = 3). Residual risk unit 214 may determine a set of residual risk scores that may include the residual risk scores of each group assigned to each risk obtained from the application domain, hosting service domain, and data center domain. Residual risk unit 214 may aggregate the set of residual risk scores to generate an aggregated residual risk score for a particular hosting environment.

Host assessment system 208 may determine an aggregated residual risk score of a current host and future host and compare the aggregated residual risk scores to determine whether assets from the current host should migrate to the future host. Host assessment system 208 may determine the aggregated residual risk scores of the current host and future host as a baseline test and output the aggregated residual risk scores via interface 204 to inform a corporation of any gaps in a corporation’s control framework and provide the corporation with an opportunity to address the gaps and/or improve the control framework. Control mapping 228 may store the control framework (e.g., cloud controls matrix) that maps control objectives (security, compliance, etc.) to the software domain, hosting service domain, and data center domain. Host assessment system 208 may automatically determine an aggregated residual risk score of a hosting environment in response to updating control objectives stored in control mapping 228 or addressing deficiencies in how the hosting environment addresses the control objectives stored in control mapping 228.

Host assessment system 208 may complete the baseline testing of the current host and future host after a user, via interface 204, indicates that all the control objectives stored in control mapping 228 have been met. In response to host assessment system 208 completing the baseline testing, residual risk unit 214 of host assessment system 208 may determine the aggregated risk scores of the current host and future host and compare whether the aggregated risk score of the future host is less than the aggregated risk score of the current host. In response to residual risk unit 214 determining the aggregated risk score of the future host is greater than the aggregated residual risk score of the current host, residual risk unit 214 may output a warning to a user via interface 204 that migrating assets to the future host is not recommended. In response to residual risk unit 214 determining the aggregated risk score of the future host is less than the aggregated residual risk score of the current host, residual risk unit may instruct host migration unit 216 to automatically migrate assets from the current host to the future host. In some instances, residual risk unit 214 may output a request via interface 204 to get a user’s approval before host migration unit 216 automatically migrates assets from the current host to the future host.

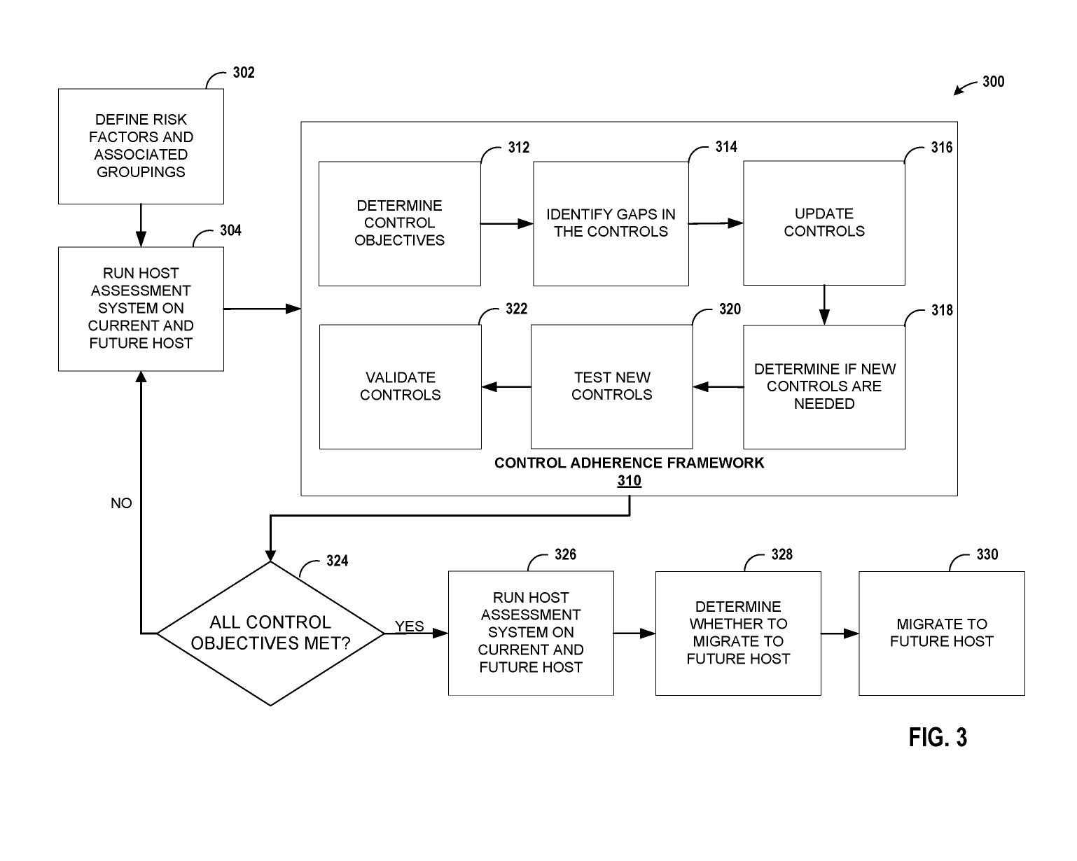

FIG. 3 is a flowchart illustrating an example operation 300 in accordance with techniques described herein. In step 302, a corporation may define risk factors and associated groupings as discussed above. In step 304, a host assessment system may incorporate the risk factors and groupings defined in step 302 to determine an aggregated risk score in accordance with the techniques previously described. The host assessment system may output the residual risk scores and the groups assigned to each risk obtained by the host assessment system. A user may use the information regarding the residual risk score of a hosting environment to address gaps in control objectives and improve control objective applied by the hosting environment. The user may address a hosting environment’s compliance with control objectives in any manner well-known in the art. For example, control adherence framework 310 may include steps the user may use to address gaps in control objectives and improve a hosting environment’s compliance with the control objectives.

In the example of FIG. 3, control adherence framework 310 provides steps a corporation may take to mitigate the aggregated residual risk score of a hosting environment and guarantee that the hosting environment complies with all the control objectives of a control framework. In step 312, a corporation may determine the control objectives according to a control framework implemented by the corporation. In step 314, the corporation may identify gaps in the controls of an analyzed hosting environment based on the aggregated residual risk score calculated by the host assessment system. In step 316, the corporation may update the scope of existing controls address the gaps identified in step 314 or in response to input from personnel of the corporation. In step 318, the corporation may determine if new controls are needed to mitigate any potential residual risks and lower the aggregated residual risk score of the analyzed hosting environment. In step 320, the corporation may perform testing of new controls to determine the effectiveness of the design of the new controls. In step 322, the corporation may validate the controls by ensuring that the analyzed hosting environment is capable of adhering to the updated or newly added control objectives. In response to the corporation updating or adding to the controls according to control adherence framework 310, the corporation may determine whether the analyzed hosting environment has met all the control objectives (324). If the analyzed hosting environment is determined to not have met all the control objectives, the host assessment system may be used to analyze the hosting environment again so the corporation may make adjustments according to control adherence framework 310. The host assessment system may iteratively determine an aggregated residual risk score of an analyzed hosting environment (304) and the corporation may iteratively determine adherence with the controls (312-322) until it is determined that the analyzed hosting environment has met all control objectives.

In response to determining that the analyzed hosting environment has met all the control objectives, the host assessment system may determine the aggregated residual risk score of the analyzed hosting environments (326). The host assessment system may determine whether to migrate assets from a current host to a future host if the aggregated residual risk score of the future host is less than the aggregated risk score of the current host (328). If the aggregated residual risk score of the future host is less than the aggregated residual risk score of the current host, the host assessment system may automatically migrate assets from the current host to the future host (330).

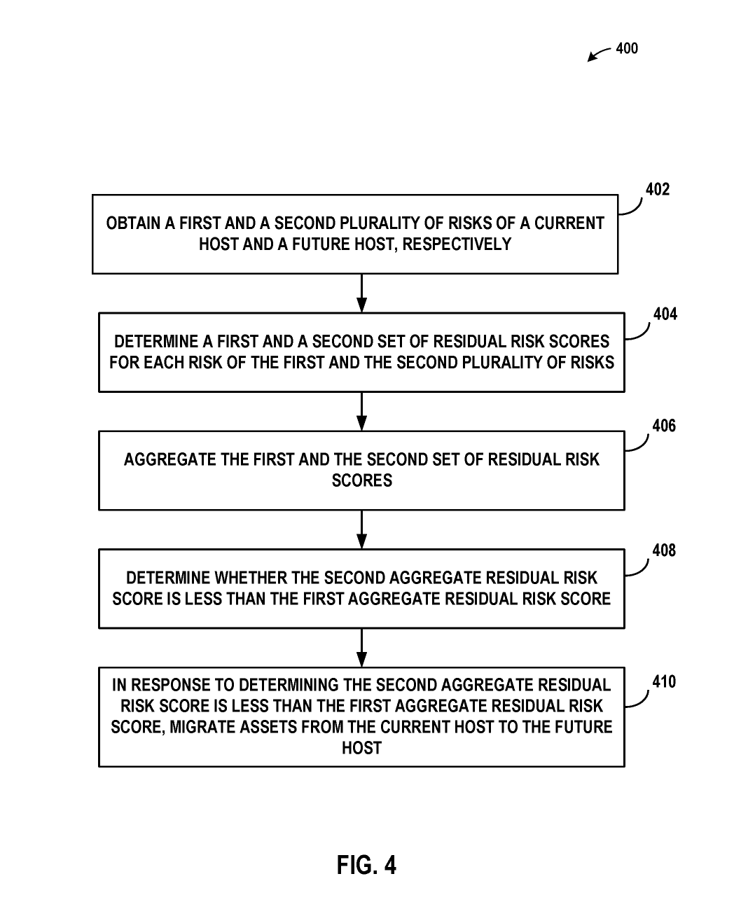

FIG. 4 is an example operation 400 in accordance with the techniques described in this disclosure. The steps of operation 400 may be done by a computing device (e.g., computing system 200 of FIG. 2). In step 402, a host assessment system (e.g., host assessment system 208 of FIG. 2) may obtain a first plurality of risks of a current host and a second plurality of risks of a future host. The host assessment system may obtain the plurality of risks of the current host and future host with one or more software tools designed to analyze data of a host to abstract risks associated with the host.

In step 404, the host assessment system may determine a first set of residual risk scores for the first plurality of risks of the current host and a second set of residual risk scores for the second plurality of risks of the future host. The host assessment system may determine the first set of residual risk scores and the second set of residual risks score with groups as discussed previously.

In step 406, the host assessment system may aggregate the first set of residual risk scores associated with the current host and the second set of residual risk scores associated with the future host. In some examples, the host assessment system may determine the aggregated residual risk score of the first set of residual risk scores and the aggregated residual risk score of the second set of residual risk scores by taking the average of residual risk scores within the respective set of residual risk scores.

In step 408, the host assessment system may determine whether the second aggregate residual risk score associated with the future host is less than the first aggregate residual risk score associated with the current host.

In step 410, the host assessment system may migrate assets from the current host to the future host in response to determining the second aggregate residual risk score associated with the future host is less than the first aggregate residual risk score associated with the current host. In some examples, the host assessment system may prompt a user via a user interface before migrating assets from the current host to the future host. If the host assessment system determines that the second aggregate residual risk score associated with the future host is greater than the first aggregate residual risk score associated with the current host, the host assessment system may issue a warning to a user via a user interface indicating that it would not be safe to migrate assets from the current host to the future host. The host assessment system may also include the first set of residual risk scores associated with the current host and the second set of residual risk scores associated with the future host in the warning to inform the user on how to mitigate residual risk associated with a particular host.

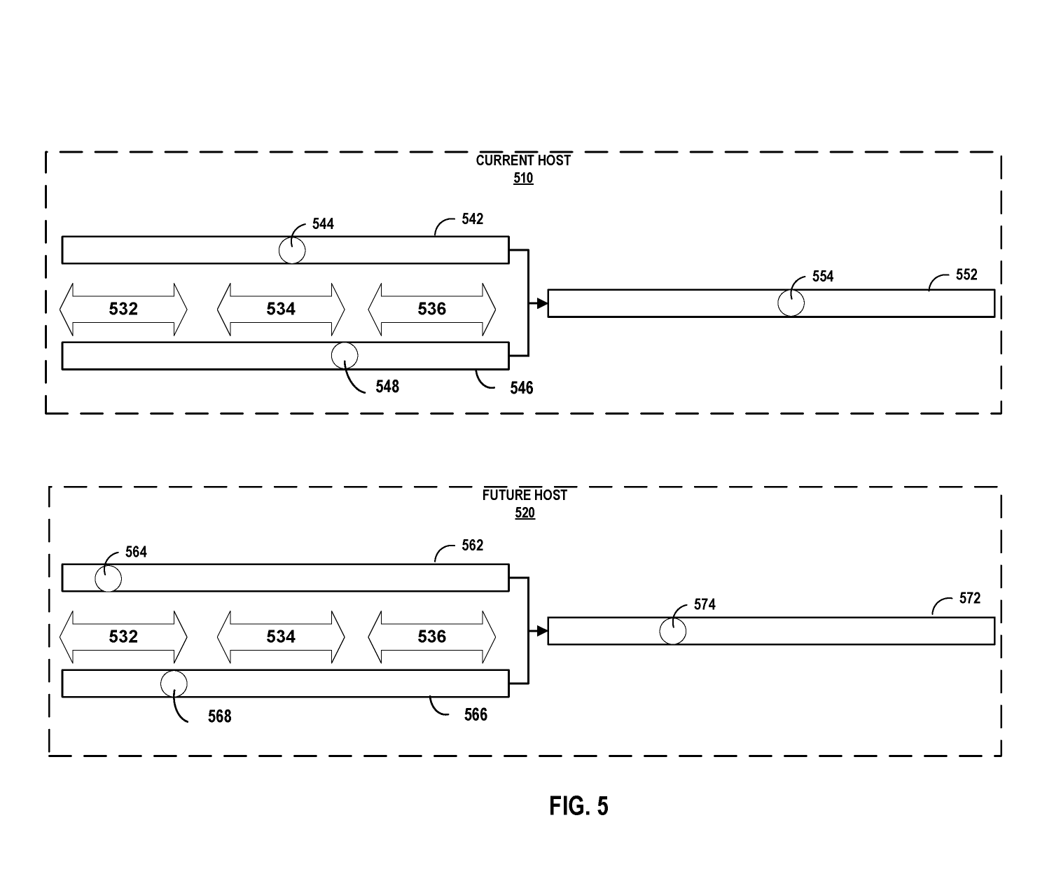

FIG. 5 is a block diagram illustrating an example operation of aggregating risk scores of a current host and a future host.

In accordance with techniques of this disclosure, a host assessment system (e.g., host assessment system 208 of FIG. 2) may aggregate quantitative and qualitative risk scores of a current host and future host to support a migration of assets to the future host. The host assessment system may aggregate quantitative residual risk score 544 of current host 510 and qualitative residual risk score 548 of current host 510 to generate an aggregated risk score 554 associated with current host 510. The host assessment system may aggregate quantitative residual risk score 564 of future host 520 and qualitative residual risk score 568 of future host 520 to generate an aggregated risk score 574 associated with future host 520.

The host assessment system may determine a quantitative residual risk score (e.g., quantitative residual risk score 544 or 564) based on a spectrum 542 or 562 and a qualitative residual risk score (e.g., qualitative residual risk score 548 or 568) based on spectrum 546 or 566. Spectrum 542, 562, 546, and 566 (hereinafter, “spectrum 542, 562, 546, 566”) may represent all possible values of one or more quantitative risks and qualitative risks ordered based on a level of risk. In the example of FIG. 5, spectrum 542, 562, 546, 566 may be created based on one or more risk factors, where the risk factor values with the least level of risk is on the far most left of spectrum 542, 562, 546, 566, the risk factor values with the most level of risk is on the far most right of spectrum 542, 562, 546, 566, and all other risk factor values are plotted in between in ascending order. The host assessment system may determine the placement of quantitative residual risk score 544 and 564 on spectrum 542 and 562, respectively, and the placement of qualitative residual risk score 548 and 568 on spectrum 546 and 566, respectively, based on data obtained from a host by a data collection unit (e.g., data collection unit 212 of FIG. 2).

In some examples, the host assessment system may create groups 532, 534, and 536 to assign an integer value to residual risk scores 544, 548, 564, and 568. In the example of FIG. 5 each group 532, 534, and 536 may include one or more number values representing potential residual risk scores and associated risk factor values. The one or more number values may be based on a level of risk of the associated risk factor values. For example, group 532 may include number values between 0 and 1.66 that correlate to a low level of quantitative and qualitative risk factor values that were plotted on spectrum 542, 562, 546, 566. Group 534 may include number values between 1.67 and 3.33 that correlate to a moderate level of quantitative and qualitative risk factor values that were plotted on spectrum 542, 562, 546, 566. Group 536 may include number values between 3.34 and 5 that correlate to a high level of quantitative and qualitative risk factor values that were plotted on spectrum 542, 562, 546, 566. Quantitative residual risk score 544 of current host 110 may, for example, be assigned a value of 2.64 based on quantitative risks of current host 110 and plotted on spectrum 542. Qualitative residual risk score 548 of current host 110 may, for example, be assigned a value of 2.88 based on qualitative risks of current host 110 and plotted on spectrum 546. Quantitative residual risk score 564 of future host 120 may, for example, be assigned a value of 0.83 based on quantitative risks of future host 120 and plotted on spectrum 562. Qualitative residual risk score 568 of future host 120 may, for example, be assigned a value of 1.67 based on qualitative risks of future host 120 and plotted on spectrum 566.

The host assessment system may determine aggregated residual risk score 554 for current host 510 and aggregated residual risk score 574 for future host 520 by taking the average of the quantitative residual risk score and the qualitative residual risk score of a given host. The aggregated residual risk score 554 may be plotted on an aggregated spectrum 552 of the current host 510, and the aggregated residual risk score 574 may be plotted on an aggregated spectrum 572 of the future host 520. Following the example above, aggregated residual risk score 554 of current host 510 would be 2.76 (i.e., the average of 2.64 and 2.88) and aggregated residual risk score 574 of future host 520 may be 1.25 (i.e., the average of 0.83 and 1.67). In this example, the host assessment system may begin to migrate assets from current host 510 to future host 520 because aggregated residual risk score 574 of future host 520 is less than aggregated residual risk score 554 of current host 510.

Various examples have been described. These and other examples are within the scope of the following claims.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interpreted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses. Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method, comprising:
obtaining, by one or more processors, current risk data representing a current operational state of an application on a current host;
obtaining, by the one or more processors, target state configuration data defining a proposed computing environment on a future host, wherein the target state configuration data comprises a control mapping that defines control objectives comprising security or compliance requirements for the future host;
determining, by the one or more processors, a second aggregate residual risk score for the future host by analyzing the control mapping associated with the future host to determine whether the proposed computing environment satisfies the control objectives, without executing the application on the future host;
determining, by the one or more processors, a first aggregate residual risk score for the current host based on the current risk data; and
automatically authorizing, by the one or more processors, a migration of the application to the future host when the second aggregate residual risk score indicates a lower risk level than the first aggregate residual risk score.

2. The method of claim 1, wherein the control mapping comprises a cloud controls matrix that maps the control objectives to a software domain, a hosting service domain, and a data center domain.

3. The method of claim 1, further comprising:
prior to authorizing the migration, identifying gaps in the control mapping where the target state configuration data fails to meet the control objectives; and
generating a remediation recommendation to address the gaps.

4. The method of claim 1, wherein calculating the second aggregate residual risk score further comprises obtaining qualitative risk data associated with the future host, wherein the qualitative risk data comprises at least one of an organization maturity score, a personnel skills score, or a migration strategy score.

5. The method of claim 1, wherein determining the second aggregate residual risk score further comprises processing quantitative risk factors associated with the future host, wherein the quantitative risk factors comprise at least one of an application health score, open remediation issues, or policy exceptions.

6. The method of claim 1, wherein determining the first aggregate residual risk score and the second aggregate residual risk score comprises:
determining distinct domain-level risk scores for a software domain, a hosting service domain, and a data center domain;
applying a predetermined weighting factor to each of the distinct domain-level risk scores to generate weighted domain-level risk scores; and
aggregating the weighted domain-level risk scores.

7. The method of claim 1, wherein obtaining the current risk data comprises:
performing a baseline assessment of the current host to identify current deficiencies in addressing the control objectives; and
determining the first aggregate residual risk score based on the current deficiencies to establish a risk baseline prior to migration.

8. The method of claim 1, further comprising:
obtaining modified target state configuration data; and
iteratively determining the second aggregate residual risk score for the future host based on the modified target state configuration data until the future host satisfies the control objectives.

9. The method of claim 1, further comprising in response to automatically authorizing the migration, automatically instructing a host migration unit to migrate the application from the current host to the future host.

10. The method of claim 1, further comprising:
automatically blocking the migration of the application to the future host when the second aggregate residual risk score indicates a risk level that is equal to or higher than the first aggregate residual risk score; and
outputting a warning indicating that the proposed computing environment for the future host poses more risk than the current host and is not recommended.

11. A device comprising:
at least one processor; and
at least one memory storing computer-executable instructions that, when executed by the at least one processor, cause the device to:
obtain current risk data representing a current operational state of an application on a current host;
obtain target state configuration data defining a proposed computing environment on a future host, wherein the target state configuration data comprises a control mapping that defines control objectives comprising security or compliance requirements for the future host;
determine a second aggregate residual risk score for the future host by analyzing the control mapping associated with the future host to determine whether the proposed computing environment satisfies the control objectives, without executing the application on the future host;
determine a first aggregate residual risk score for the current host based on the current risk data; and
automatically authorize a migration of the application to the future host when the second aggregate residual risk score indicates a lower risk level than the first aggregate residual risk score.

12. The device of claim 11, wherein the control mapping comprises a cloud controls matrix that maps the control objectives to a software domain, a hosting service domain, and a data center domain.

13. The device of claim 11, wherein the computer-executable instructions further cause the device to:
prior to authorizing the migration, identify gaps in the control mapping where the target state configuration data fails to meet the control objectives; and
generate a remediation recommendation to address the gaps.

14. The device of claim 11, wherein the computer-executable instructions that cause the device to determine the second aggregate residual risk score further cause the device to obtain qualitative risk data associated with the future host, wherein the qualitative risk data comprises at least one of an organization maturity score, a personnel skills score, or a migration strategy score.

15. The device of claim 11, wherein the computer-executable instructions that cause the device to determine the second aggregate residual risk score further cause the device to process quantitative risk factors associated with the future host, wherein the quantitative risk factors comprise at least one of an application health score, open remediation issues, or policy exceptions.

16. The device of claim 11, wherein the computer-executable instructions that cause the device to determine the first aggregate residual risk score and the second aggregate residual risk score cause the device to:
determine distinct domain-level risk scores for a software domain, a hosting service domain, and a data center domain;
apply a predetermined weighting factor to each of the distinct domain-level risk scores to generate weighted domain-level risk scores; and
aggregate the weighted domain-level risk scores.

17. The device of claim 11, wherein the computer-executable instructions that cause the device to obtain the current risk data cause the device to:
perform a baseline assessment of the current host to identify current deficiencies in addressing the control objectives; and
determine the first aggregate residual risk score based on the current deficiencies to establish a risk baseline prior to migration.

18. The device of claim 11, wherein the computer-executable instructions further cause the device to:
receive modified target state configuration data; and
iteratively determine the second aggregate residual risk score for the future host based on the modified target state configuration data until the future host satisfies the control objectives.

19. The device of claim 11, wherein the computer-executable instructions further cause the device to, in response to automatically authorizing the migration, automatically instruct a host migration unit to migrate the application from the current host to the future host.

20. A non-transitory computer readable storage medium storing instructions that, when executed, cause one or more processors of a server device to:
obtain current risk data representing a current operational state of an application on a current host;
obtain target state configuration data defining a proposed computing environment on a future host, wherein the target state configuration data comprises a control mapping that defines control objectives comprising security or compliance requirements for the future host;
determine a second aggregate residual risk score for the future host by analyzing the control mapping associated with the future host to determine whether the proposed computing environment satisfies the control objectives, without executing the application on the future host;
determine a first aggregate residual risk score for the current host based on the current risk data; and
automatically authorize a migration of the application to the future host when the second aggregate residual risk score indicates a lower risk level than the first aggregate residual risk score.
